(19) United States
(12) Patent Application Publication
(10) Pub. No.: US 2013/0018679 A1
(43) Pub. Date: Jan. 17, 2013

(54) 3D version of self-changing a hotel, motel, resort room , a theater, stadium or an arena seat & business solution for their businesses

(71) Applicant: Qiuhang Qian, Marble Falls, TX (US)

(72) Inventor: Qiuhang Qian, Marble Falls, TX (US)

(73) Assignee: Qiuhang Richard Qian, Marble Falls, TX (US)

(21) Appl. No.: 13/136,535

(22) Filed: Aug. 4, 2011

Related U.S. Application Data
(60) Provisional application No. 61/508,044, filed on Jul. 14, 2011.

(51) Int. Cl. G06Q 10/00

(52) U.S. Cl. 705/5

(57) ABSTRACT

A revolutionary self-choosing a hotel, motel, resort room, a theater, stadium, or an arena seat online and business solution for their businesses are invented. The customer can check any available rooms on different floors in a hotel, motel or resort and the seats in a theater, stadium or an arena. A hotel, motel, resort, theater, stadium and arena can be any one in a city or out of a city. The e-commerce web application contains two modules. One is for the customer. The other is for the business' internal use. Both of them will be developed by computer language either .net, java or other named language. The web application will be carefully integrated with the current businesses' system. .Net or java or other named language is computer development language. They contain logic rules, packages, procedures, and triggers along with other development tools. The consumer and the hotel, motel, resort, entertainment and sports businesses will take different steps before they can reach the desired results. The results can be a room is reserved, a ticket is bough or the backbone management tasks are taken etc.

Choosing a hotel, motel, resort room, a theater, stadium or an arena seat by oneself online and the business solution for their businesses have been invented. By choosing a room or seat, the customer can select any available room on any floor in any hotel, motel or resort and pick any seat that is marked with a seat number in a theater, stadium or an arena replacing the current business model (Reserve a room(s) in a hotel, motel or resort without knowing which room(s) to stay; Seat number in a theater, stadium or an arena is randomly assigned). The invention also comes with the web management solution for the internal use.

The web application will help the customer check the room or seat availability. The customer can choose a room or a seat he or she likes and make reservation or purchase a ticket online. It will reduce waiting time when checking in a hotel, motel or resort. It will also bring the flexibility either to reserve or buy a ticket online or at the ticket booth.

The customer logs onto the internet and accesses to the website where on the first page a 3D virtual simulation of a hotel, theater, stadium or an arena will rotate and display for 5 seconds before it stops. There is a search block on the upper right corner for the customer to search. The search is for searching a hotel, motel, or resort; the search can find discount or specials as well. After the search is done, the results will appear on the screen. The results shown will be the 3D image simulations of all the hotels, motels and resorts. The theater, stadium or arena can be accessed by typing its address. The 3D simulation of the theater, stadium or arena will show on the page.

Pointing the cursor to a 3D facility photo image, it shows the business' address and contact information. Clicking it, the graphic hotel, motel, resort, theater, stadium or arena's layout floor plan shows on the screen. The customer can check rooms on different floors or seats in a theater, in the sections in a stadium or arena. After checking, the customer can make reservation or buy a ticket by clicking that room or seat. The reservation will be made or a ticket will be reserved or bought online. All the information will be saved on the server.

The customer who reserves the room online shows the ID and credit card at the hotel, motel or resort counter. The paperwork and key are ready at the counter. The customer service compares the IDs with the information on the reservation sheet. It is ready to check in after that. The customer who reserves or buys the ticket online shows the ID and reservation sheet at the ticket booth. The customer service prints the ticket(s) after verifying the information.

### BACKGROUND OF THE INVENTION

Hotels and other accommodations include all types of lodging, from luxurious five-star hotels to youth hostels and recreational vehicle parks. While many provide simply a place to spend the night, others cater to longer stays by providing food service, recreational activities, and meeting rooms. In 2010, there are over 64,000 establishments provided accommodations to suit many different needs and budgets. Hotels and other accommodations provided 1.9 million wage and salary jobs. Employment is concentrated in cities and resort areas.

Hotel staffs provide a variety of services to guests and must do so efficiently, courteously, and accurately. They must maintain a pleasant demeanor even during times of stress or when dealing with an impatient or irate guest. Alternately, work at slower times, such as the off-season or overnight periods, can seem slow and tiresome. Still, hotel workers must be ready to provide guests and visitors with gracious customer service at any hour. Work in hotels and other accommodations can be demanding and hectic—processing orders and invoices, dealing with demanding guests, or servicing requests that require a quick turnaround.

The total attendances for the professional, college games and performance arts shows pass 210 million in 2010. Most attendances bought tickets at the ticket booth. Some ordered from online.

With the current invention, the customer can pick a seat that is available in a theater, stadium or arena. It provides the choice for the customer to have a seat anywhere he or she likes. The hotel staffs can reduce and balance the workload; improve efficiency if the customer can choose a room and make reservation online by himself or herself.

### TECHNICAL FIELD

The present invention relates to the website, computer and server systems that are capable of running and support e-commerce application and programs. More particularly, the present invention relates to the systems that are capable of running web application and provide online self-choosing a hotel, motel, resort room, a theater, stadium or an arena seat and managing related contents for the hotel, motel, resort, sports and entertainment businesses.

### BRIEF DESCRIPTION OF THE DRAWINGS

FIG. 1 is an example design layout showing how a hotel floor plan looks like on the web page.

FIG. 2 is an example page design layout showing how the internal management console looks like on the local businesses' computers.

FIG. 3 is a logic process flow diagram illustrating how technically the platform is created for the customer to choose services including reserving a room.

FIG. 4 is a logic process flow diagram illustrating how technically the platform is created for the hotel, motel and resort businesses to create the tasks and manage the contents.

FIG. 5 is an example design layout showing how a theater floor plan looks like on the web page.

FIG. 6 is an example page design layout showing how the internal management console looks like on the local businesses' computers.

FIG. 7 is a logic process flow diagram illustrating how technically the platform is created for the customer to choose services including choosing a seat and buying a ticket online.

FIG. 8 is a logic process flow diagram illustrating how technically the platform is created for the entertainment and sports businesses to create the tasks and manage the contents.

### DETAILED DESCRIPTION OF EXEMPLARY EMBODIMENTS

The present invention provides the solution for self-choosing a hotel, motel, resort room, a theater, stadium or an arena seat online and the solution for their businesses through the developed procedures and tools. The local businesses are required to have the authority to access to the Management Console. They are granted to have the privilege by the corporate office to do so. The local and corporate office can create, modify, delete, move, upload, check the status etc. The businesses can perform different tasks and follow the procedures developed for them in the Management Console. Any related contents that are created or modified will be saved on the server. There are some programs that will automatically run to help the web application run smoothly on the server. The customer doesn't need to create an account, but the records of staying hotels will be saved for different purposes. They can be retrieved from the server.

Although the preferred embodiment will be generally described in the context of website, programs and operating systems running on the computers and servers, those skilled in the art will recognize that the present invention also can be implemented in conjunction with other program modules for different types of computers and servers. Furthermore, those skilled in the art will recognize that the present invention may be implemented in different network environments.

For example, in a two-tier network, a user communicates directly with a server. This is also known as a client-server architecture. A client-server network is an architecture that involves user processes that request service from server processes. The user and server communicate over a network using a given protocol, which must be installed on both the user and the server. In an N-tier architecture, the role of the middle-tier agent can be manifold. It can provide: translation services (as in adapting a legacy application on a mainframe to a user-server environment or acting as a bridge between protocols); scalability services (as in acting as a transaction-processing monitor to balance the load of requests between servers); intelligent agent services (as in mapping a request to a number of different servers, collating the results, and returning a single response to a user).

In a complex network environment, different hardware platforms run different operating systems; multiple protocols are used on these platforms; variable syntax exist between the different but connected applications; run on different geographical locations in which the connected applications reside. It supports a large-scale distributed system. In a distributed computing environment, program modules may be physically located in different local and remote memory storage devices. Execution of the program modules many occur locally in a stand-alone manner or remotely in a user server manner. Examples of such distributed computing environments include local area networks of an office, enterprise-wide computer networks and the global internet.

The detailed description which follows is represented largely in terms of processes and symbolic representations of operations by conventional computer components, including a central processing unit (CPU), memory storage devices for the CPU, display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network. The processes and operations performed by the computer include the manipulation of signals by a CPU or remote server and the maintenance of these signals within data structures resident in one or more of the remote memory storage devices.

For the purpose of this discussion, a process is generally conceived to be a sequence of computer-executed steps leading to a desired result. These steps usually require physical manipulation of physical quantities. Usually, though not necessarily, these quantities take the form of electrical, magnetic, or optical signals capable of being stored, transferred, combined, compared, or otherwise manipulated. It is convention for those skilled in the art to refer to representation of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as creating, adding, changing, modifying, saving, calculating, updating, moving, receiving, determining, identifying, populating, loading, executing, etc. that are often associated with manual operations performed by a human operator. The operations described herein can be machine operations performed in conjunction with various input provided by a human operator or a user that interacts with the computer.

In addition, it should be understood that the programs, processes, methods, etc. described herein are not related or limited to any particular computer or apparatus. Rather various types of general purpose machines may be used with the program modules constructed in accordance with the teachings described herein. Similarly, it may prove advantageous to construct a specialized apparatus to perform the method steps described herein by the way of dedicated computer systems in specific network architecture with hardwired logic or programs stored in nonvolatile memory, such as ready-only memory.

Such data structures impose a physical organization upon the collection of data stored within a memory storage device and represent specific electrical or magnetic elements. These symbolic representations are the means used by those skilled in the art of computer programming and computer construction to most effectively convey teachings and discoveries to other skilled in the art. Now referring to the figures:

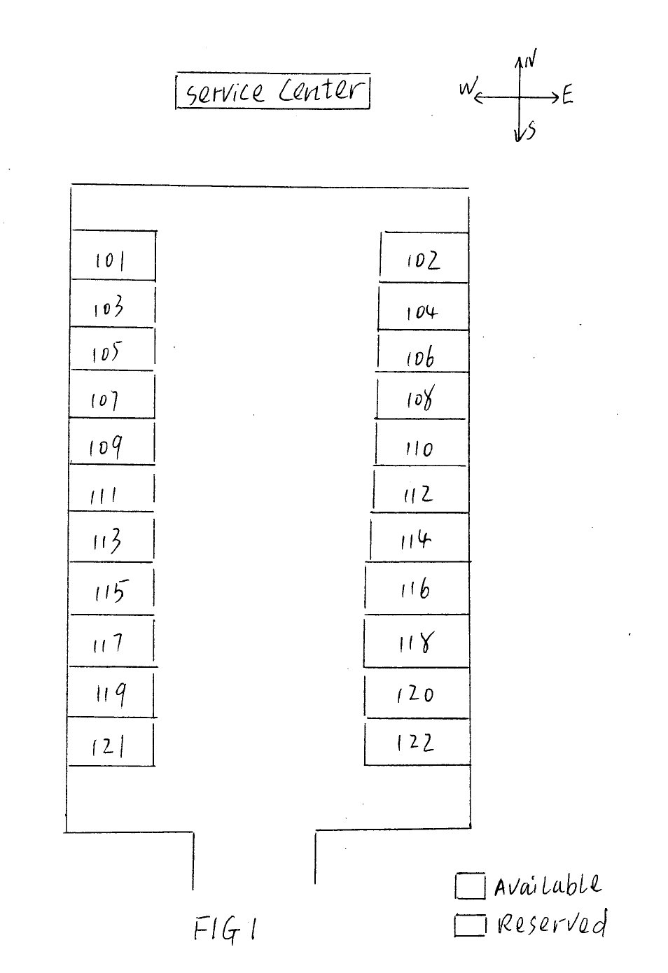

FIG. 1 is a web page showing a hotel's floor plan with the room numbers on each room. FIG. 1 is an example. Different hotels, motels and resorts have different number of floors, rooms and floor plans. They have different sizes, shapes and directions. All the information including the floor plans, location and contact information will be gathered from the companies. There is a compass on the upper right corner of the page indicating the direction. There are signs that will show the entrance, parking lot and other facilities if available. If the rooms are not vacant, they show the color of red; if they are available, they show the color of green. Two tabs of the colors are put at the right bottom part with description. There is a floor tab under the color tabs for checking the rooms on the different floors. The rooms with numbers will be used for making reservation.

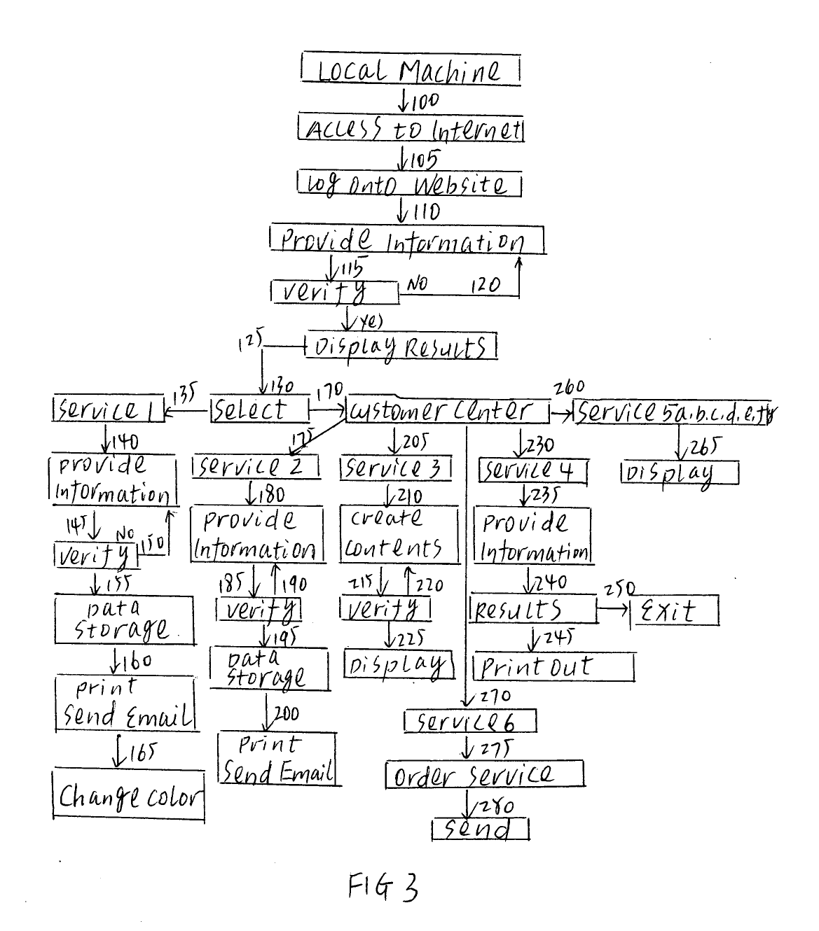

There is a customer service center tab on the top middle part of the page. It will be linked to other services. See FIG. 3 for the detail description.

The interfaces the hotel, motel and resort pages are developed by computer development language. It could be Java, .Net, Ruby on Rails etc. The development languages are stored program units. They will enable the customer and the local businesses to access and manipulate information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of constructs. Procedures and functions are identical except that functions always return a single value to the caller, while the procedures do not. The trigger is a program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The tools include word processing editor etc.

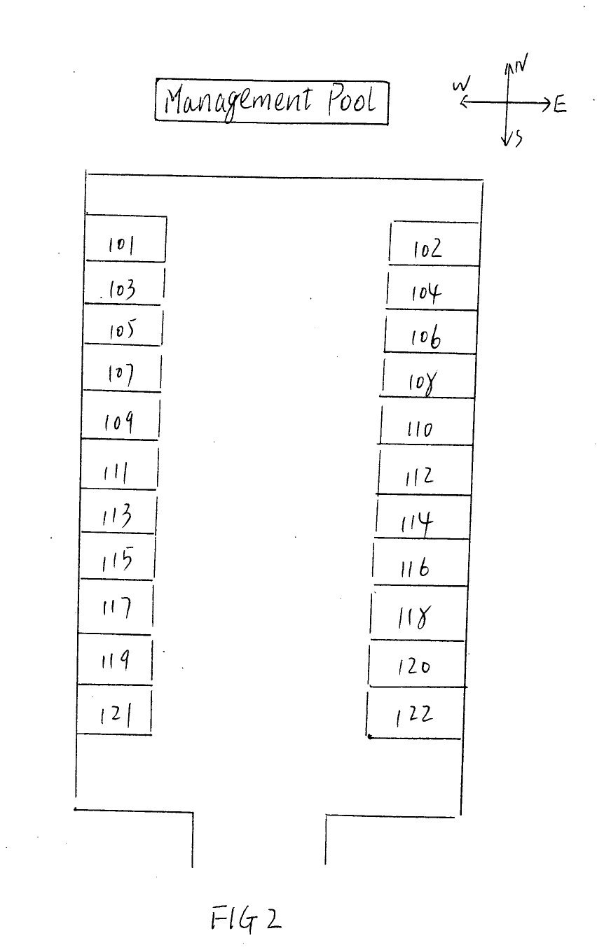

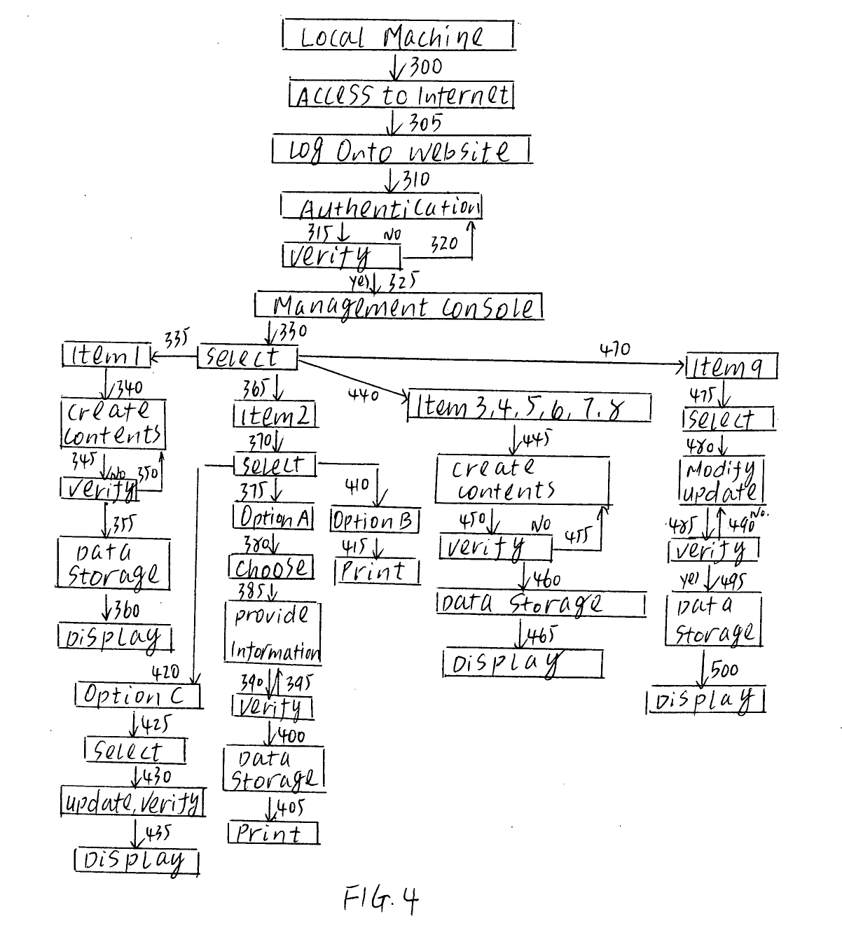

FIG. 2 is a web page showing the internal Management Console for the hotel, motel and resort businesses. It has the exact same page layout as the FIG. 1 except the color of the page is different and the tab on the top middle will be the Management Console. The local businesses can perform different tasks from here including creating the material information for their businesses. For the management tasks, see FIG. 4 for the detail description.

The Management Console interfaces are developed by computer development language. It could be Java, .Net, Ruby on Rails etc. The development languages are stored program units. They will enable the customers and the local businesses to access and manipulate information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of constructs. Procedures and functions are identical except that functions always return a single value to the caller, while the procedures do not. The trigger is a program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A).The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The tools include word processing editor etc.

FIG. 3, the customer logs onto a local computer, connects to the internet and accesses to the web server (Step 100, 105). The connection is a communication pathway between the user process and the server process. A process created on the client is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the returned result is sent back to the customer.

The web application displays graphic interface which is the first page of the website. The first page is made up of two different items. Items are used to present information from the database or to act as control. The web application is event-driven. When an event occurs, the application responds to it. An event is either an interface event, which corresponds to a customer action, or an internal processing event, which corresponds to a system action.

The first item is the virtual 3D hotel designed and placed in the middle of the screen. The second item is the search block. The 3D hotel will rotate and display for 5 seconds before it stops. The search block is put at the right upper corner. Step 110 is the step to provide information to search a hotel, motel or resort location. The provided information needs to be verified (Step 115). If the information cannot be found in the database, the process goes back to the step 110 through the step 120. During the verification, a development program function is invoked. It provides a default verification routine to verify the validity of the data in the database. The procedure returns the value TRUE for success and FALSE for failure. If the verification raises an exception, the data becomes invalid, an error is returned.

If the data are valid, the page will show all the hotels, motels or resorts within the search criteria with their 3D images (Step 125). The next step 130 is checking with any hotel, motel or resort by pointing and clicking the image. If the image is pointed by the cursor, the information of the hotel, motel or resort appears on the screen. It includes the address and contact information. If it is clicked, it goes to the hotel, motel or resort's first floor layout plan page where it shows all the rooms and other facilities if available. The rooms with numbers are for online reservation.

The next step is picking a service 1 (Step 135). Service 1 is for self-choosing a room and making reservation online. The customer can keep checking all the available rooms on any floor until he or she finds the one he or she likes. If the available room is pointed, it will enlarge with small tabs that can be linked to show the room interior with photo or video format or both. There is also a reserve tab attached. If it is clicked, the reservation form will show on the screen. The next step is the step to fill out the reservation form (Step 140). The provided reservation information needs to be verified (Step 145). If the data are not valid, the process goes back to the step 140 until the valid data are provided through the step 150. If the data are valid, they will be saved on the server under LogC (Step 155). The customer can print out the reservation form or choose to send the reservation information to his or her email account (Step 160). The reserved room changes color from green to red (Step 165).

The database is a collection of data. During the save stage, the server records the data and writes them to the data blocks in the database from database buffer cache. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity. The room reservation cannot be made beyond a month.

The customer can also make general reservation from the customer service center where other different services are provided. Step 170 is the step to check the customer service center. Step 175 is the step to pick service 2. Service 2 is about general room reservation without choosing a particular room. If the customer chooses this service, he or she needs to provide the necessary information (Step 180). After the data are provided, they need to be verified (Step 185). If the data are not valid, they need to be provided again until they are valid though the step 190. If the data are valid, they will be saved on the server under LogG (Step 195). The next step is the step that the customer either chooses to print out the reservation form or send the reservation form to his or her email account (Step 200).

Service 3 is about customer comments and suggestion. If the customer selects the service 3 (Step 205), he or she needs to create contents (Step 210). The created contents need to be verified (Step 215). If they are not good, the process goes back to the step 210 through the step 220. If the contents are good, they will be displayed (Step 225).

Service 4 is about stay records. If the customer chooses this service 4(step 230), he or she needs to provide personal information (Step 235). After the customer provides the information, the results will show on the screen (Step 240). If the result is good, the customer can print it out and use it (Step 245) or the customer can exit if there is no result (Step 250). The result is related to reward program.

The next step is the step to choose service either 5a, 5b, 5c, 5d, 5e, 5f if it has or 5g (Step 255). Service 5a is about promotion. It shows the specials or discount for the hotel, motel or resort; service 5b is anything that the hotel, motel or resort has for sale; service 5c is the location map; service 5d is found and lost; 5e shows the future events; 5f is about the restaurant(s) and cocktail lounge(s) if the hotel or resort has. 5g is about the services provided by the hotel or resort. The contents under each service will be displayed if they are checked (Step 260). The process ends when the customer leaves each service (Step 265). Step 270 is the step to select service 6. Service 6 is about ordering a service. After the request is made, it will be sent (Step 275, 280).

Online hotel, motel or resort reservation self-choosing a room and reserving a room(s) module is developed by Java, .net or other named language. .Net, Java or other named language is a computer language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object. The design tools for creating the contents and processes are developed by .net, java or other named language.

The stored procedure is a procedure or function. It consists of a set of constructs. Procedures and functions are identical except that functions always return a single value to the caller, while the procedures do not. The trigger is a program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The design tools for creating the contents and process are also developed by .net, java or other named language. The tools include word processing editor etc.

FIG. 4, the local hotel, motel or resort business logs onto the company's computer, connects to the internet and accesses to the web server (Step 300, 305). The connection is a communication pathway between the local business and the server process. The connection is a communication pathway between the user process and the server process. A process created on the client is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the returned result is sent back to the local hotel, motel or resort business.

The next step 310 is authentication. The local business provides the access information to be authenticated (Step 315). If the authentication is not valid, the process needs repeat until the valid access data are provided through the step 320. If the authentication is valid, it will enter the Management Console (Step 325). During the authentication, a development program function is invoked. It provides a default verification routine to verify the validity of the data. The procedure returns the value TRUE for success and FALSE for failure. If the verification raises an exception, the data becomes invalid, an error is returned. The Management Console is made up of different items. Items are used to present information from the database or to act as control. The web application is event-driven. An event occurs and the application responds to it. An event is either an interface event, which corresponds to a customer action, or an internal processing event, which corresponds to a system action.

Step 330 is the step to select an item from the Management Console. If item 1 is selected (Step 345), it is where content materials are created including hotel, motel or resort information and map etc. Item 1 is the Creation Log. The next step is creating (Step 340). The creating process includes entering room numbers, floors, uploading photo images and videos for the floor, room and other objects etc. After it is done, all the created contents need to be verified (Step 345). If the contents are not satisfactory or incorrect, they need to be re-created through the step 350. If the contents are good, they will be saved in the database on the server and displayed under the customer service page (Step 355, 360).

The database is a collection of data. During the save stage, the server records the data and writes them to the data blocks in the database from database buffer cache. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Step 365 is the step to select item 2. Item 2 is the Walk-In, Reserve and Update Log. All the walk-ins, online reservations, updating and other management functions are created under here. Step 370 is the step to select a task. If option A is selected (Step 375), a room needs to be chosen for the customer (Step 380). Option A is for walk-in customers. After a room is decided, all the information needs to be entered in the order form (Step 385). The next step is the step to verify (Step 390). If the data are not valid, the step goes back and the correct data needs to be provided until they are valid (Step 395). If the data are valid, they will be saved on the server (Step 400). The next step is the step to print out the order form (Step 405). If option B is selected, the front desk can either chooses to go to LogC or LogG (Step 410). The next step 415 is printing the reservation sheet and put it in a designated area with the key(s). If option C is selected (Step 420), the checked out rooms need to be selected (Step 425). Step 430 is the step to update and verify. After the verification, the updated new setting will show (Step 435).

Step 440 is the step to create contents for item 3, 4, 5, 6, 7, or 8. Item 3 is about promotional discounts or specials. It allows the corporate or local business to create promotional contents in the form of banner ads. Item 4 is about found and lost. Item 5 is about merchants for sale. Item 6 is about restaurant and cocktail lounge. Item 7 and 8 are events and services. The next step is the step to create contents (Step 445). All the created contents need to be verified (Step 450). If the contents are not good or satisfactory, they need to be re-created through the step 455. If the contents are good, they will be saved in the database on the server and displayed (Step 460, 465).

Step 470 is the step to select the repository (Item 9). There are different items in the repository for modifying and management. Step 475 is the step to select and step 480 is the step to modify, delete, update and save etc. After it is done, the next step is verifying (Step 485). If the modified or updated contents are not satisfactory, they need to be re-created or modified through the step 490. If the contents are satisfactory, they will be saved in the database on the server and displayed in the designated area (Step 495, 500).

The internal web management module is developed by Java, .net or other named language. .Net, Java or other named language is a computer language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object. The design tools for creating the contents and processes are developed by .net, java or other named language.

The stored procedure is a procedure or function. It consists of a set of constructs. Procedures and functions are identical except that functions always return a single value to the caller, while the procedures do not. The trigger is a program unit that is executed implicitly by the server when a specific type of event occurs. The trigger is never called; it only executes when the event occurs.

A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The design tools for creating the contents and process are also developed by .net, java or other named language. The tools include word processing editor etc.

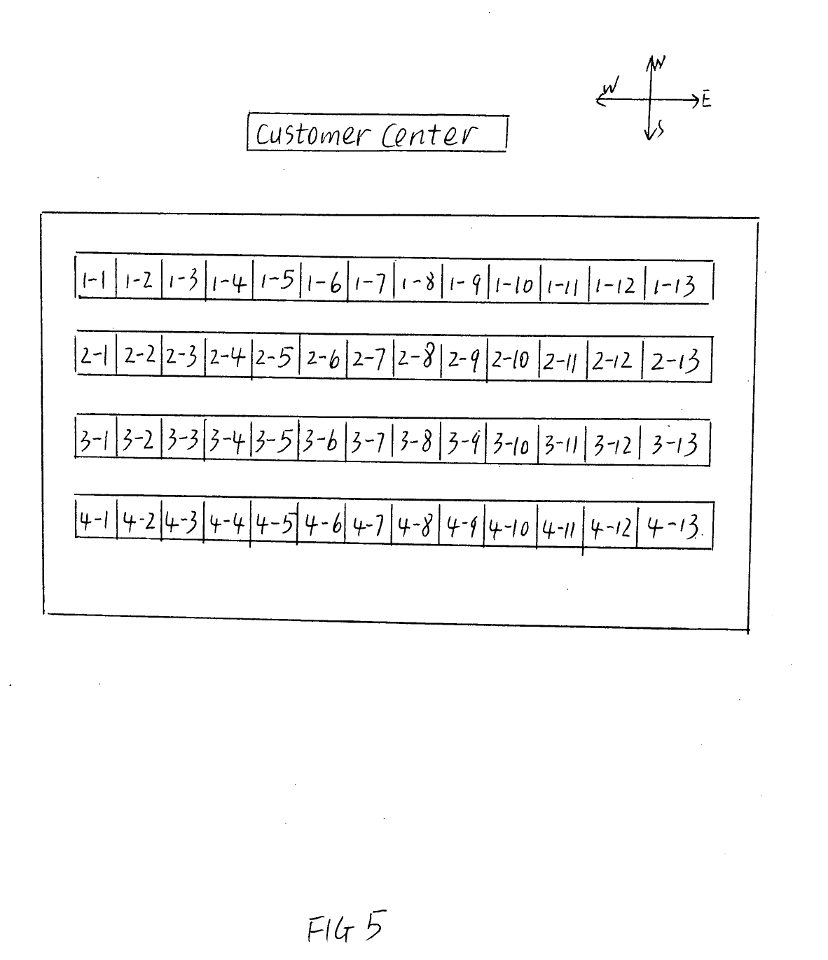

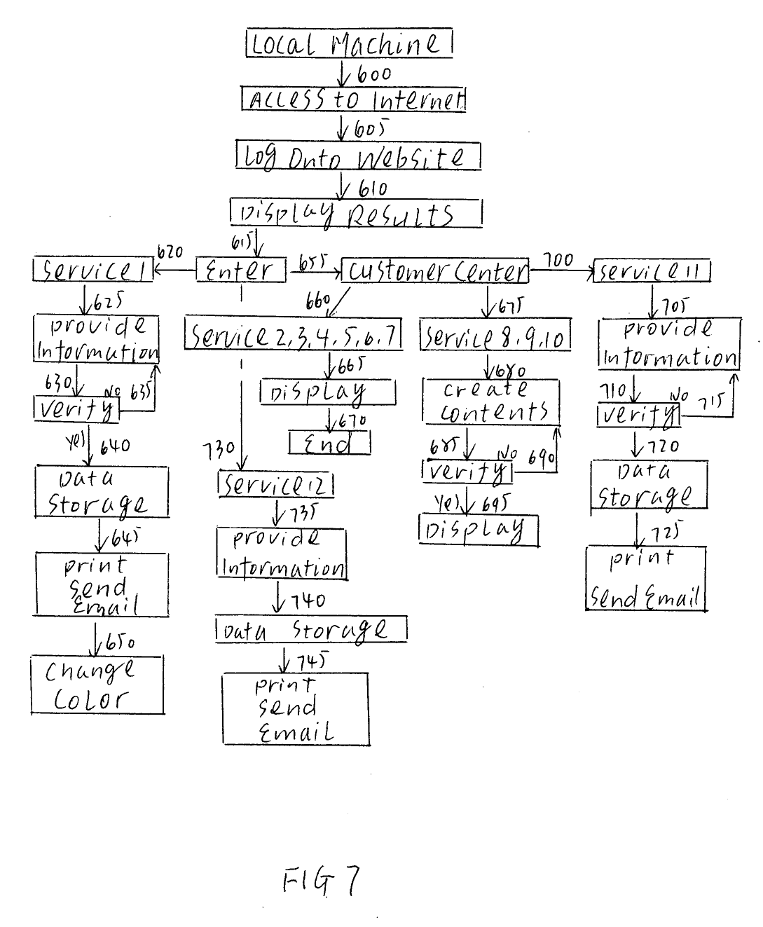

FIG. 5 is an example web page showing the theater floor plan with the seat numbers on each row. FIG. 5 is an example. Different theaters, stadiums or arenas have different number of seats and settings. The floor plans and other information of the theaters, stadiums and arenas will be gathered from the businesses. There is a compass on the upper right corner of the page indicating the direction. There are signs that will show the entrance, parking lot and other facilities if available. If the seats have not been reserved, they show the color of green; if they have been reserved, they show the color of red. Two tabs of the colors are put at the right bottom part with description. Each section of the stadium and arena will be enlarged if it is pointed. The seats with the numbers will be used for making reservation. There is a customer service center tab on the top middle part of the page. It will be linked to other services. See FIG. 7 for the detail description.

The interfaces of the theater, stadiums and arenas are developed by computer development language. It could be Java, .Net or Ruby on Rails etc. The development languages are stored program units. They will enable the customer and the local businesses to access and manipulate information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of constructs. Procedures and functions are identical except that functions always return a single value to the caller, while the procedures do not. The trigger is a program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The tools include word processing editor etc.

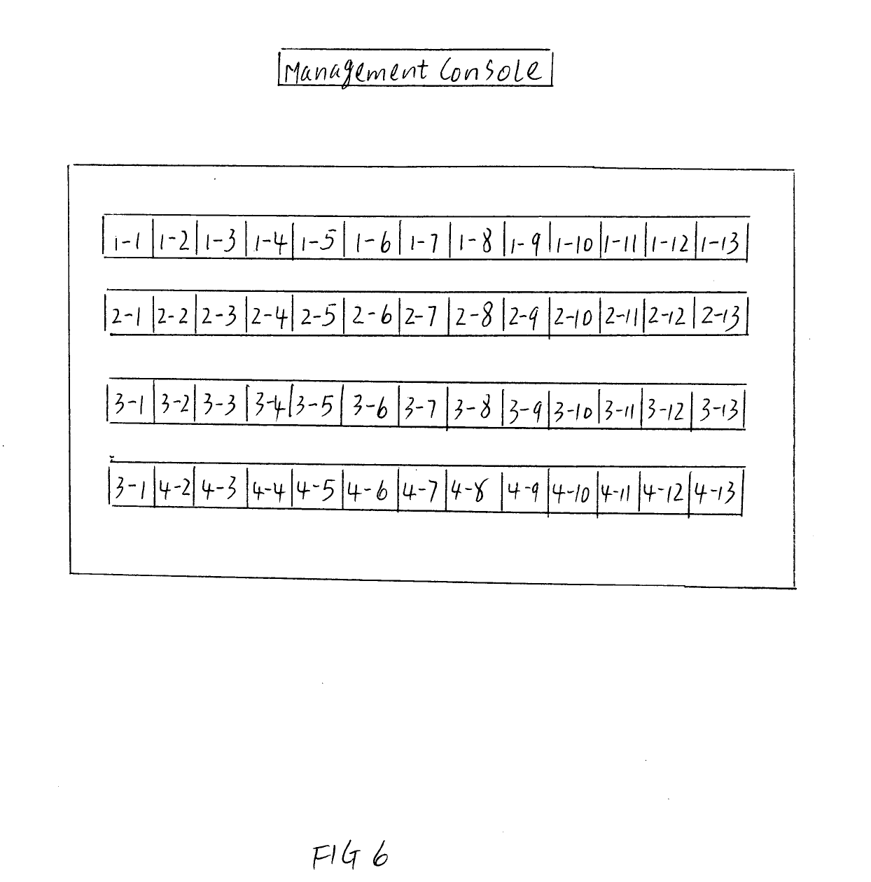

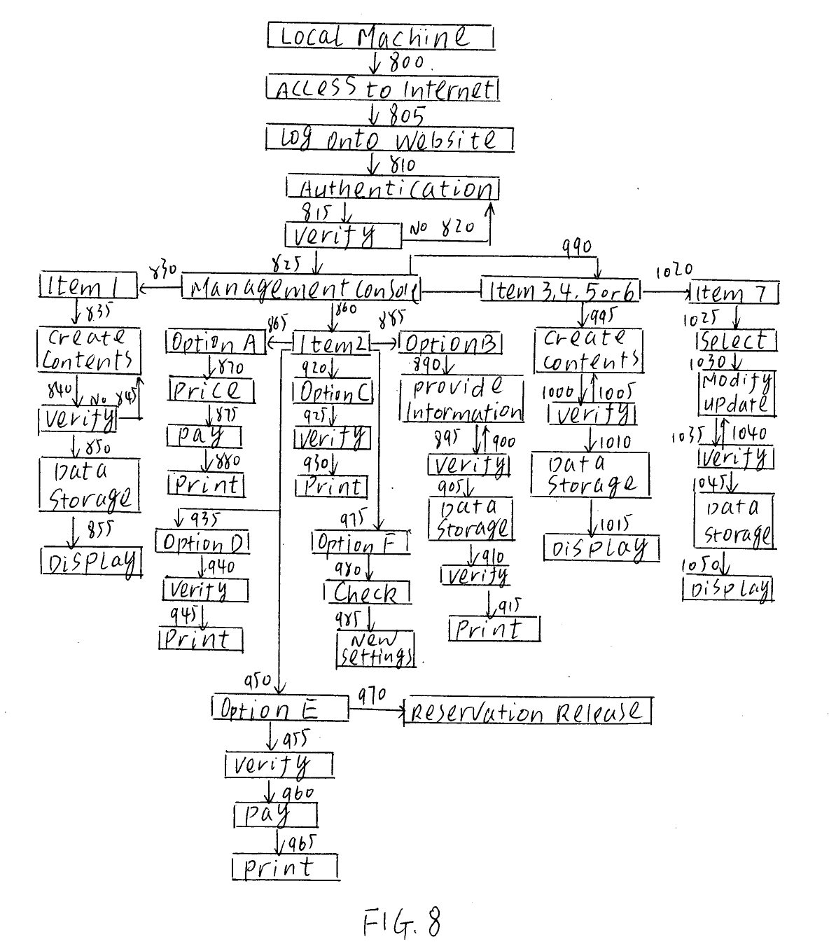

FIG. 6 is a web page showing the internal Management Console for the theater, stadium and arena businesses. It has the exact same page layout as the FIG. 5 except the color of the page is different and the tab on the top middle will be the Management Console. The local businesses can perform different tasks from here including creating the materials for their businesses. For the management tasks, see FIG. 8 for the detail description.

The Management Console interfaces are developed by computer development language. It could be Java, .Net or Ruby on Rails etc. The development languages are stored program units. They will enable the customers and the local businesses to access and manipulate information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of constructs. Procedures and functions are identical except that functions always return a single value to the caller, while the procedures do not. The trigger is a program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The tools include word processing editor etc.

FIG. 7 is a logic process flow diagram illustrating how technically the platform is created for the customer to choose the services including choosing a seat and buying a ticket online. The customer logs onto a local computer, connects to the interne and accesses to the web server (Step 600, 605). The connection is a communication pathway between the user process and the server process. A process created on the client is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the returned result is sent back to the customer.

The web application displays the graphic interface which is the first page of the website (Step 610). On the first page a 3D photo image simulation of the theater, stadium or arena will rotate and display for 5 seconds before it stops. The 3D image simulation is an item. The item is used to present information from the database. The web application is event-driven. When an event occurs, the application responds to it. An event is either an interface event, which corresponds to a customer action, or an internal processing event, which corresponds to a system action.

The next step 615 is the step to enter the theater, stadium or arena by clicking the image. The next step is picking a service 1 (Step 620). Service 1 is for self-choosing a seat online. The customer can keep checking all the available seats in the theater, in any section of the stadium or arena until he or she finds the one he or she likes. When the seats are checked, the seats section area will enlarge. If a seat is clicked, the reservation form will show on the screen. The next step is the step to fill out the reservation form (Step 625). The provided reservation information needs to be verified (Step 630). If the data are not valid, the process goes back to the step 625 until the valid data are provided through the step 635. If the data are valid, they will be saved on the server under LogC (Step 640). The customer can print out the reservation form or choose to send the reservation to his or her email account (Step 645). The reserved seat changes color from green to red (Step 650).

The database is a collection of data. During the save stage, the server records the data and writes them to the data blocks in the database from database buffer cache. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

The customer can also make general reservation from the customer service center where other different services are provided. Step 655 is the step to check the customer service center. Step 660 is the step to pick service 2, 3, 4, 5, 6, or 7. Service 2 is about monthly event schedules; service 3 is about found and lost; service 4 is about food, beverage items and vendors; service 5 is about merchants for sale; service 6 is for ordering tickets over the phone and contact information; and service 7 are the maps inside and outside for the business. The contents under each service will be displayed if they are checked (Step 665). The process ends when the customer leaves each service (Step 670).

The next step 675 is the step to select service 8, 9 or 10. Service 8 is about need and sell tickets; service 9 is carpool request; and service 10 is about customer's comments and suggestion. If the customer selects either one of the three services, he or she needs to create contents (Step 680). The created contents need to be verified (Step 685). If they are not good, the process goes back to the step 680 through the step 690. If the contents are good, they will be displayed (Step 695).

Service 11 is about ordering ticket(s) without choosing a particular seat (Step 700). If the customer chooses this service, he or she needs to provide the information (Step 705). After the data are provided, they need to be verified (Step 710). If the data are not valid, they need to be provided again though the step 715. If the data are valid, they will be saved on the server under LogG (Step 720). The next step is the step that the customer either chooses to print out the reservation form or send the reservation to his or her email account (Step 725). Service 12 is about making ticket reservation online or over the phone (Step 730). If the customer chooses this service, he or she needs to provide the information (Step 735). After the data are provided, they will be saved on the server under LogR (Step 740). The next step is the step that the customer either chooses to print out the reservation ticket or send the reservation ticket to his or her email account (Step 745).

Online theater, stadium or arena reservation self-choosing a seat module is developed by Java, .net or other named language. .Net, Java or other named language is a computer language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object. The design tools for creating the contents and processes are developed by .net, java or other named language.

The stored procedure is a procedure or function. It consists of a set of constructs. Procedures and functions are identical except that functions always return a single value to the caller, while the procedures do not. The trigger is a program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The design tools for creating the contents and process are also developed by .net, java or other named language. The tools include word processing editor etc.

FIG. 8 is a logic process flow diagram illustrating how technically the platform is created for the entertainment and sports businesses to create the tasks and manage the contents. The local theater, stadium or arena business logs onto the company's computer, connects to the interne and accesses to the web server (Step 800, 805). The connection is a communication pathway between the local business and the server process. The connection is a communication pathway between the user process and the server process. A process created on the client is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the returned result is sent back to the local theater, stadium or arena business.

The next step 810 is authentication. The local business provides the access information to be authenticated (Step 815). If the authentication is not valid, the process needs repeat until the valid access data are provided through the step 820. If the authentication is valid, it will enter the Management Console (Step 825). During the authentication, a program function is invoked. It provides a default verification routine to verify the validity of the data. The procedure returns the value TRUE for success and FALSE for failure. If the verification raises an exception, the data becomes invalid, an error is returned. The Management Console is made up of different items. Items are used to present information from the database or to act as control. The web application is event-driven. An event occurs and the application responds to it. An event is either an interface event, which corresponds to a customer action, or an internal processing event, which corresponds to a system action.

Step 830 is the step to select item 1 from the Management Console. Item 1 is the Creation Log. It is where the content materials are created including creating the seat numbers and other contents (Step 835). The next step is the step to verify (Step 840). If the contents are not satisfactory or incorrect, they need to be re-created through the step 845. If the contents are good, they will be saved in the database on the server and displayed under the customer service page (Step 850, 855).

The database is a collection of data. During the save stage, the server records the data and writes them to the data blocks in the database from database buffer cache. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Step 860 is the step to select item 2. Item 2 is the Tickets, Reservation and Update log. The customer can purchase tickets at site, over the phone, and online. The internal customer representative can do all the things for the customer and updates the seats from here. Step 865 is the step to select option A. Option A is purchasing ticket at site. The price for a seat needs to be decided (Step 870). The next two steps are making payment and printing the ticket(s) (Step 875, 880). Option B is about purchasing ticket(s) over the phone (Step 885). The customer needs to provide personal and payment information (Step 890). The provided information needs to be verified (Step 895). If the provided information is not correct, the process needs to repeat until the correct information is provided (Step 900). If the provided information is correct, the purchasing information will be saved on the server under LogP (Step 905). The next step is the step that the customer shows the ID and verifies the phone number at the ticket booth (Step 910). After the verification, the ticket(s) will be printed (Step 915). Option C is the option regarding choosing a seat and buying a ticket online (Step 920). The next step is the step that the customer shows the printed bought ticket receipt at the ticket booth (Step 925). After the verification, the ticket(s) is printed (Step 930). Option D is the option regarding buying a ticket(s) online without choosing a particular seat (Step 935). The next step is the step that the customer shows the printed bought ticket receipt at the ticket booth (Step 940). After the verification, the ticket(s) is printed (Step 945). Option E is the option regarding making ticket reservation online or over the phone (Step 950). The next step is the step that the customer shows the ID and verifies the phone number (Step 955). If it is matched, the next step is making payment (Step 960). And the ticket will be printed after making the payment (Step 965). All the seat tickets which are reserved will be released 5 minutes before the event begins (Step 970). Option F is the option that the internal staff or management updates the seats (Step 975). The next step is the step to check the update box (Step 980). After it is checked, the customer service related web pages show new settings (Step 985).

Step 990 is the step to create contents for item 3, 4, 5, or 6. Item 3 is about event schedules. It allows the corporate or local business to create event schedules from here. Item 4 is about found and lost. Item 5 is about the merchants for sale. Item 6 is about food, beverage items and vendors. The next step is the step to create contents (Step 995). All the created contents need to be verified (Step 1000). If the material contents are not good or satisfactory, they need to be re-created through the step 1005. If the contents are good, they will be saved in the database on the server and displayed (Step 1010, 1015).

Step 1020 is the step to select item 7. Item 7 is the repository. There are different items in the repository for modifying and management. Step 1025 and 1030 are the two steps to select a task to modify, delete, update and save etc. Such tasks for example can be updating merchants for the For Sale etc. After each task is taken, the next step is verifying (Step 1035). If the modified or updated contents are not satisfactory, they need to be re-created or modified through the step 1040. If the contents are satisfactory, they will be saved and displayed in the designated area (Step 1045, 1050).

The internal web management module is developed by Java, .net or other named language. .Net, Java or other named language is a computer language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object. The design tools for creating the contents and processes are developed by .net, java or other named language.

The stored procedure is a procedure or function. It consists of a set of constructs. Procedures and functions are identical except that functions always return a single value to the caller, while the procedures do not. The trigger is a program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The design tools for creating the contents and process are also developed by .net, java or other named language. The tools include word processing editor etc.

1. Self-Choosing a Hotel, Motel, Resort Room, a Theater, Stadium or an Arena Seat & Business Solution for Their Businesses
